(19) United States
(12) Patent Application Publication
(10) Pub. No.: US 2009/0272266 A1
(43) Pub. Date: Nov. 5, 2009

(54) METHOD FOR OXYGENATING GASES, SYSTEMS SUITED THEREFOR AND USE THEREOF

(75) Inventors: Steffen Werth, Solingen (DE); Baerbel Kolbe, Witten (DE)

Correspondence Address: CONNOLLY BOVE LODGE & HUTZ, LLP, P O BOX 2207, WILMINGTON, DE, 19899, US

(73) Assignees: Uhde GmbH, Dortmund (DE); BORSIG Process Heat Exchanger GmbH, Berlin (DE)

(21) Appl. No.: 11/815,794

(22) PCT Filed: Jan. 23, 2006
(86) PCT No.: PCT/EP2006/000545

§ 371 Date: Mar. 26, 2009

(30) Foreign Application Priority Data
Feb. 11, 2005 (DE) 10 2005 006 571.6

(51) Int. Cl. B01D 53/22

(52) U.S. Cl. 95/54; 96/8; 96/7

(57) ABSTRACT

A process for enriching the content of oxygen in oxygen- and nitrogen-containing gases in a separation apparatus which has an interior which is divided into a substrate chamber and into a permeate chamber by an oxygen-conducting ceramic membrane is described. The process comprises the introduction of oxygen- and nitrogen-containing sweep gas into the permeate chamber and the establishment of a pressure in the substrate chamber so that the oxygen partial pressure in substrate chamber and sweep chamber results in the transfer of oxygen through the ceramic membrane.

The process is distinguished by high operational safety.

The present invention relates to an improved process for the oxygen enrichment and an improved plant therefor.

Oxygen transfer membranes (also referred to below as “OTM”) are ceramics having particular composition and lattice structure which have the capability of oxygen conduction at relatively high temperatures. Consequently, oxygen can be separated selectively, for example from air. The driving force of the transfer of the oxygen from one side of the membrane to the other is the different oxygen partial pressure on the two sides.

Attempts have been made for some time to make use of the long-known effect of the selective oxygen conduction for the recovery of oxygen or directly for the production of synthesis gas.

Two different methods have been proposed for generating the driving force for the oxygen transfer. Either the oxygen diffusing through the ceramic is allowed to react immediately on the permeate side or the oxygen is swept away from the permeate side of the membrane by means of a sweep gas. Both methods lead to a low oxygen partial pressure on the permeate side.

During the operation of OTM, membrane thicknesses of substantially less than 1 mm and temperatures of about 800 to 900° C. are typically used. It is known that the oxygen transfer through thicker membranes is dependent on the logarithm of the quotient of the different oxygen partial pressures. It is also known that, in the case of very thin membranes, it is no longer the logarithm of the quotient which is decisive but presumably only the difference between the oxygen partial pressures.

Several patents in the area of OTM systems start from direct coupling of reaction and oxygen transfer. Either a catalyst is applied directly to the membrane or a catalyst bed is used adjacent to the membrane. During operation, an oxidizing agent is introduced into this system on one side of the membrane and an oxidizable medium on the other side, the two media being separated only by a thin ceramic membrane. Examples of such directly coupled systems are to be found in U.S. Pat. No. 5,591,315, U.S. Pat. No. 5,820, 655, U.S. Pat. No. 6,010,614, U.S. Pat. No. 6,019,885, EP-A-399,833, EP-A-882,670 and EP-A-962,422.

Directly coupled systems are still in need of improvement in many respects. Thus, firstly problems of operational safety which result, for example, from the brittleness of the ceramic membrane which is typical of the material have to be overcome. At the high reaction temperatures, this may constitute a serious safety problem if said membranes break and oxygen and agent to be oxidized mix at high temperatures. In addition, the oxygen permeation may increase exponentially with increasing temperature, and there is the danger of a runaway reaction in the case of an exothermic reaction.

Further possible problems of coupled systems are the tendency to cokings of the permeate side of the membrane, a nonuniform temperature distribution in the reactor when exothermic and endothermic reactions are combined on the permeate side of the membrane, the limited chemical stability of the membrane or the influence of leaks in the metal seal/ceramic composite.

The safety problems described above can in principle be circumvented and the reaction technology can be simplified by separating mass transfer through the membrane and actual oxidation reaction. The oxygen is separated off on the permeate side of the membrane by a sweep gas which takes up the oxygen and brings it into contact in a further physically separated reactor (part) with the medium to be oxidized.

The patent literature describes different sweep gases, for example steam or waste gases from combustion reactions (i.e. mainly CO₂). Examples of these decoupled systems are to be found in U.S. Pat. No. 6,537,465, EP-A-1,132,126, U.S. Pat. No. 5,562,754, U.S. Pat. No. 4,981,676, U.S. Pat. No. 6,149,714. The sweep gases used in these systems may contain small proportions of oxygen.

In these patent documents, air is used as an oxygen supplier on the feed side. The driving force of the oxygen transfer is generated by virtue of the fact that an oxygen-free or virtually oxygen-free sweep gas reduces the concentration of the oxygen on the permeate side. The use of oxygen-containing sweep gases, for example of air, is not disclosed. Although EP-A-1,132,126 and U.S. Pat. No. 5,562,754 refer to “sweep gas which does not react with air”, only the use of steam is mentioned in the specific description.

The background is that firstly there is no difference or only a slight difference in the oxygen partial pressure on the two sides of the membrane (and consequently no oxygen permeation or only a reduced oxygen permeation takes place when using oxygen-containing sweep gases. In addition, with the use of air as sweep gas, nitrogen can be used therein, the presence of which is a wish to avoid in many oxidation reactions.

Starting from this prior art, it was the object of the present invention to provide an improved process for recovering oxygen from oxygen-containing gases, which has improved operational safety and which permits a stable procedure even in the case of exothermic reactions.

A further object of the present invention was to provide an improved process for recovering oxygen from oxygen-containing gases which can be operated for a long time without changing the membrane and which has a high error tolerance with respect to leaks in the membrane or in the metal seal/ceramic composite.

The present invention relates to a process for enriching the content of oxygen in oxygen- and nitrogen-containing gases in a separation apparatus which has an interior which is divided into a substrate chamber and into a permeate chamber by an oxygen-conducting ceramic membrane, comprising the steps:
a) compression and heating of an oxygen-containing gas to give a feed gas,
b) introduction of the compressed and heated feed gas into the substrate chamber of the separation apparatus,
c) introduction of an oxygen- and nitrogen-containing sweep gas into the permeate chamber of the separation apparatus,
d) establishment of a pressure in the substrate chamber so that the oxygen partial pressure of the feed gas causes transfer of oxygen through the oxygen-conducting ceramic membrane into the permeate chamber,
e) removal of the feed gas depleted in oxygen from the substrate chamber, and
f) removal of the oxygen-enriched sweep gas from the permeate chamber.

In contrast to the approaches followed to date, it is proposed according to the invention to use an oxygen- and nitrogen-containing gas as sweep gas on the permeate side.

For a number of chemical syntheses, for example for the ammonia synthesis, nitrogen is useful in the sweep gas so that there is the possibility of sweeping the permeate side with oxygen- and nitrogen-containing gas, preferably with air, and generating the driving force of the oxygen permeation by virtue of the fact that the gas pressure on the feed side of the membrane is higher than on the permeate side of the membrane. Oxygen partial pressures on the two sides therefore differ, and oxygen flows through the membrane.

This process has a number of advantages compared with the systems proposed to date.
The system has intrinsic safety. If a membrane breaks, oxygen-containing gas mixes with oxygen-containing gas.
Since no exothermic reaction takes place, a runaway reaction in the separation apparatus is ruled out.
Since preferably no oxidizable components, such as hydrocarbons, occur in the separation apparatus, coking is ruled out.
Since no chemical reactions take place in the separation apparatus, there are no problems with nonuniform temperature distributions.
Since most membrane materials have long-term stability in oxygen-containing gases, the chemical stability of the membrane is ensured.
A completely gas-tight connection between the metallic seal and the ceramic membrane components is not necessary and small “leaks” can be tolerated.
By controlling the pressure on the oxygen-supplying side of the membrane, the degree of enrichment of the oxygen-containing gas can be regulated in a very elegant manner. For example, it would be possible to tolerate individual fractured membrane pieces. It is true that nitrogen would then also flow to the permeate side through these fracture points and would reduce the enrichment. However, this could be compensated by simply increasing the pressure on the oxygen-supplying side. The oxygen flow through the undamaged parts of the membrane would thus increase and the same enrichment as before would be achieved overall. Defects occurring during operation of the membrane could thus be tolerated within limits.

Any desired oxygen-containing gases can be used as feed gas. These preferably additionally contain nitrogen and in particular no oxidizable components. Air is particularly preferably used as feed gas. The oxygen content of the feed gas is typically at least 5% by volume, preferably at least 10% by volume, particularly preferably 10-30% by volume.

Any desired oxygen- and nitrogen-containing gases can be used as sweep gases. These preferably contain no oxidizable components. The oxygen content of the sweep gas is typically at least 5% by volume, preferably at least 10% by volume, particularly preferably 10-30% by volume. The nitrogen content of the sweep gas is typically at least 15% by volume, preferably at least 35% by volume, particularly preferably 35-80% by volume. The sweep gas may optionally contain further inert components, such as steam and/or carbon dioxide. Air is particularly preferably used as sweep gas.

In the process according to the invention, any desired oxygen-conducting ceramic membranes which are selective for oxygen can be used.

The oxygen-transferring ceramic materials used according to the invention are known per se.

These ceramics may consist of materials conducting oxygen anions and conducting electrons. However, it is also possible to use combinations of a very wide range of ceramics or of ceramic and nonceramic materials, for example combinations of ceramics conducting oxygen anions and ceramics conducting electrons or combinations of different ceramics which in each case conduct oxygen anions and electrons or of which not all components have oxygen conduction or combinations of oxygen-conducting ceramic materials with nonceramic materials, such as metals.

Examples of preferred multiphase membrane systems are mixtures of ceramics having ion conductivity and a further material having electron conductivity, in particular metal. These include in particular combinations of materials having fluorite structures or fluorite-related structures with electron-conducting materials, for example combinations of ZrO₂ or CeO₂, which are optionally doped with CaO or Y₂O₃, with metals, such as with palladium.

Further examples of preferred multiphase membrane systems are mixed structures having a partial perovskite structure, i.e. mixed systems, various crystal structures of which are present in the solid, and at least one of which is a perovskite structure or a structure related to perovskite.

Further examples of preferably used oxygen-transferring ceramic materials are porous ceramic membranes which, owing to the pore morphology, preferentially conduct oxygen, for example porous Al₂O₃ and/or porous SiO₂.

Preferably used oxygen-transferring materials are oxide ceramics, of which those having a perovskite structure or having a brownmillerite structure or having an aurivillius structure are particularly preferred.

Perovskites used according to the invention typically have the structure ABO_{3-δ}, A being divalent cations and B being trivalent or higher-valent cations, the ionic radius of A being greater than the ionic radius of B and δ being a number between 0.001 and 1.5, preferably between 0.01 and 0.9, and particularly preferably between 0.01 and 0.5, in order to establish the electroneutrality of the material. In the perovskites used according to the invention, mixtures of different cations A and/or cations B may also be present.

Brownmillerites used according to the invention typically have the structure A₂B₂O_{5-δ}, A, B and δ having the meanings defined above. In the brownmillerites used according to the invention, mixtures of different cations A and/or cations B may also be present.

Cations B can preferably occur in a plurality of oxidation states. Some or all cations of type B can, however, also be trivalent or higher-valent cations having a constant oxidation state.

Particularly preferably used oxide ceramics contain cations of type A which are selected from cations of the second main group, of the first subgroup, of the second subgroup, of the lanthanides or mixtures of these cations, preferably from Mg²⁺, Ca²⁺, Sr²⁺, Ba²⁺, Cu²⁺, Ag²⁺, Zn²⁺, Cd²⁺ and/or of the lanthanides.

Particularly preferably used oxide ceramics contain cations of type B which are selected from cations of groups IIIB to VIIIB of the Periodic Table of the Elements and/or the lanthanide group, the metals of the third to fifth main group or mixtures of these cations, preferably from Fe³⁺, Fe⁴⁺, Ti³⁺, Ti⁴⁺, Zr³⁺, Zr⁴⁺, Ce³⁺, Ce⁴⁺, Mn³⁺, Mn⁴⁺, Co²⁺, Co³⁺, Nd³⁺, Nd⁴⁺, Gd³⁺, Gd⁴⁺, Sm³⁺, Sm⁴⁺, Dy³⁺, Dy⁴⁺, Ga³⁺, Yb³⁺, Al³⁺, Bi⁴⁺ or mixtures of these cations.

Yet further particularly used oxide ceramics contain cations of type B which are selected from Sn²⁺, Pb²⁺, Ni²⁺, Pd²⁺, lanthanides or mixtures of these cations.

Aurivillites used according to the invention typically have the structural element (Bi₂O₂)²⁺(VO_{3.5[ ]0.5})²⁻ or related structural elements, [ ] being an oxygen defect.

The pressure of the feed gas in the substrate chamber may vary within wide ranges. The pressure is chosen in the individual case so that the oxygen partial pressure on the feed side of the membrane is greater than on the permeate side. Typical pressures in the substrate chamber are in the range between 10⁻² and 100 bar, preferably between 1 and 80 bar, and in particular between 2 and 10 bar.

The pressure of the gas in the permeate chamber may also vary within wide ranges and is set in the individual case according to the abovementioned criterion. Typical pressures in the permeate chamber are in the range between 10⁻³ and 100 bar, preferably between 0.5 and 80 bar, and in particular between 0.8 and 10 bar.

The temperature in the separation apparatus is to be chosen so that as high a separation efficiency as possible can be achieved. The temperature to be chosen in the individual case depends on the type of membrane and can be determined by the person skilled in the art by routine experiments. For ceramic membranes, typical operating temperatures are in the range from 300 to 1500° C., preferably from 650 to 1200° C.

In a preferred process variant, the sweep gas discharged from the permeate chamber and enriched with oxygen is used for producing synthesis gas. For this purpose, a hydrocarbon mixture, preferably natural gas, or a pure hydrocarbon, preferably methane, with the sweep gas enriched with oxygen, optionally together with steam, is converted into hydrogen and oxides of carbon in a reformer in a manner known per se. After further working-up steps for removing the oxides of carbon, the synthesis gas can optionally be used in the Fischer-Tropsch synthesis or in particular in the ammonia synthesis.

In this process variant, the sweep gas is typically enriched up to about 35% to 45% oxygen content and is fed directly into a preferably autothermal reformer (“ATR”).

In a further preferred process variant, the nitrogen-containing sweep gas discharged from the permeate chamber and enriched with oxygen is used for carrying out oxidation reactions, in particular in the production of nitric acid or in the oxidative dehydrogenation of hydrocarbons, such as propane.

In yet another preferred process variant, the nitrogen-containing feed gas discharged from the substrate chamber and depleted in oxygen is used for carrying out oxidation reactions, in particular for the regeneration of coke-laden catalysts.

The invention also relates to particularly designed plants for enriching oxygen in gases.

An embodiment of this plant comprises the elements:
A) separation apparatus in the interior of which a multiplicity of hollow fibers parallel to one another and comprising oxygen-conducting ceramic material are arranged, the interiors of the hollow fibers forming a permeate chamber of the separation apparatus and the outer environment of the hollow fibers forming a substrate chamber of the separation apparatus,
B) at least one component which consists of a plurality of hollow fibers which are connected at the end faces to a supply line for a sweep gas and to a discharge line for a permeate gas enriched with oxygen, supply line and discharge line for the sweep gas and permeate gas not being connected to the substrate chamber,
C) at least one supply line for an oxygen-containing feed gas which opens into the substrate chamber of the separation apparatus, and
D) at least one discharge line leading from the substrate chamber of the separation apparatus, for discharging the feed gas depleted in oxygen from the substrate chamber.

A further embodiment of the plant according to the invention comprises the elements:
A′) separation apparatus in the interior of which a multiplicity of hollow fibers parallel to one another and comprising oxygen-conducting ceramic material are arranged, the interiors of the hollow fibers forming a substrate chamber of the separation apparatus and the outer environment of the hollow fibers forming a permeate chamber of the separation apparatus,
B′) at least one component which consists of a plurality of hollow fibers which are connected at the end faces to a supply line for an oxygen-containing feed gas and to a discharge line for a feed gas depleted in oxygen, supply line and discharge line for the feed gas and the depleted feed gas not being connected to the permeate chamber,
C′) at least one supply line for a sweep gas which opens into the permeate chamber of the separation apparatus, and
E′) at least one discharge line leading from the permeate chamber of the separation apparatus, for discharging the sweep gas enriched with oxygen from the permeate chamber.

The individual hollow fibers in the components B) and B′) can be separated spatially from one another or can touch one another. The hollow fibers are connected via a distributor unit and a collector unit to the supply line and discharge line for the gas to be transferred through the hollow fibers.

The separation apparatuses A) and A′) can be passively heated by the temperature of the gas to be introduced. The separation apparatuses A) and A′) can additionally be equipped with a heating apparatus.

A further embodiment of the plant according to the invention comprises the elements:
E) a plurality of stacked plates or layers of oxygen-conducting ceramic material which form a plurality of spaces arranged vertically or horizontally and parallel,
F) some of the spaces constitute permeate chambers and the other spaces form substrate chambers, and at least one dimension of the spaces is in the range of less than 10 mm, preferably less than 2 mm, the oxygen transfer between substrate and permeate chambers being effected with at least one common wall of the spaces which is formed by a common plate of oxygen-conducting ceramic material,
G) lines for supplying an oxygen-containing feed gas to the substrate chambers which are connected to at least one distributor unit, the distributor unit being connected to a supply line for the feed gas,
H) lines for discharging a feed gas depleted in oxygen from the substrate chambers which are connected to at least one collector unit, the collector unit being connected to a discharge line for the feed gas depleted in oxygen,
I) lines for supplying a sweep gas to the permeate chambers which are connected s to at least one distributor unit, the distributor unit being connected to a supply line for the sweep gas,
J) lines for discharging a sweep gas enriched with oxygen from the permeate chambers which are connected to at least one collector unit, the collector unit being connected to a discharge line for the sweep gas enriched with oxygen, and
K) permeate chambers and substrate chambers not being connected to one another.

In a preferred embodiment of the plant described above, spacer elements are provided in all cases.

In a preferred embodiment of the plants described above, the supply lines to the substrate chamber and/or the permeate chamber are connected to compressors, by means of which the gas pressure in the chambers can be set independently.

In a further preferred embodiment of the plants described above, the supply line to the permeate chamber is connected to a container from which the plant is supplied with oxygen- and nitrogen-containing sweep gas.

The use, according to the invention, of a separation apparatus having an OTM in chemical reactions, such as the ammonia synthesis, leads to advantageous operational and capital costs. Thus, a separation apparatus having an OTM can be operated at lower operating pressures compared with an air separation plant and can therefore be used more advantageously with regard to energy. Furthermore, the considerable investment in an air separation plant can be saved by the process according to the invention.

The invention furthermore relates to the use of gas enriched with oxygen and originating from a separation apparatus having an oxygen-conducting membrane for producing synthesis gas, preferably for use in the Fischer-Tropsch synthesis or in the ammonia synthesis.

The invention furthermore relates to the use of gas enriched with oxygen and originating from a separation apparatus having an oxygen-conducting membrane in the production of nitric acid.

The following examples and figures explain the invention without limiting it.

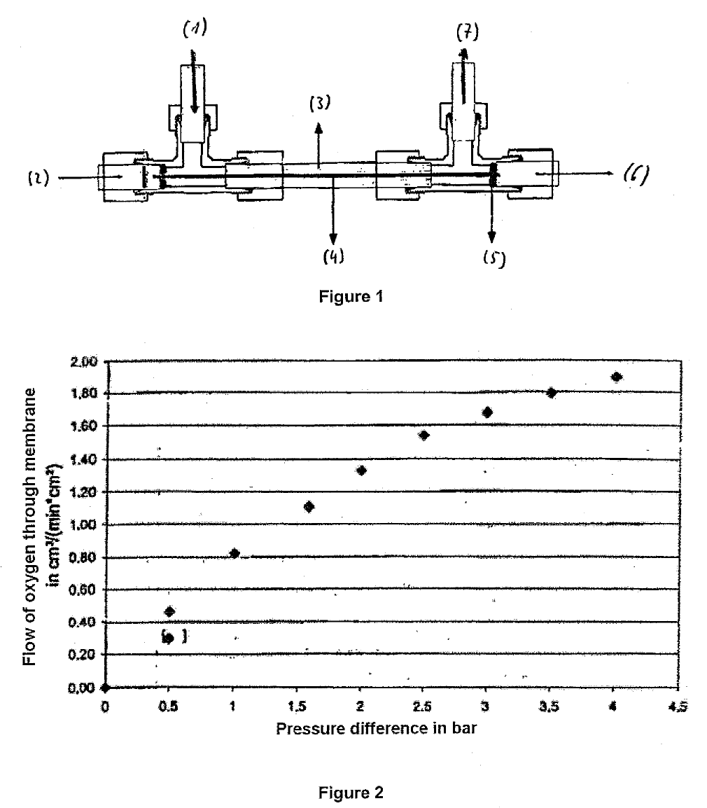

FIG. 1 shows the experimental apparatus. A hollow fiber (4) comprising oxygen-conducting ceramic material is clamped in a heatable apparatus. The ends of the hollow fiber (4) are sealed by means of silicone seals (5). The core side and the shell side of the hollow fiber (4) can be exposed to various gases and/or experimental conditions. The sweep gas introduced through the supply line (1) into the apparatus and flowing along in the permeate chamber (3) takes up oxygen, at suitable partial pressures, from the oxygen-supplying gas (“feed gas”) introduced into the apparatus and flowing along inside the interior of the hollow fiber (4) (“substrate chamber”) and leaves the apparatus as gas enriched with oxygen via the discharge line (7). The gas enriched with oxygen can then be analyzed by gas chromatography The oxygen-supplying gas is passed via the supply line (2) into the hollow fiber (4) and leaves the apparatus as gas depleted in oxygen via the discharge line (6).

The permeated amount of oxygen can be determined from the difference between the oxygen concentrations at the reactor entrance and exit (2, 6) and the total volume flow.

Different experiments were carried out. For this purpose, the ceramic hollow fiber was exposed to air as sweep gas and as oxygen-supplying gas. For establishing a suitable oxygen partial pressure, the core side of the hollow fiber was subjected to an increased atmospheric pressure while the air pressure on the shell side was left in each case at 1.2 bar.

FIG. 2 shows the oxygen flow rates achieved by the ceramic hollow fiber as a function of the pressure difference between the two sides of the ceramic membrane. It is clear that an increase in the oxygen permeation takes place with the increasing pressure difference. The measured value in square brackets in FIG. 2 is determined at a higher absolute pressure (shell side 2 bar; core side 2.5 bar). The measurements were effected at an oven temperature of 875° C. The volume flows on the shell side and core side of the hollow fiber were in each case 80 cm³_{NTP}/min (NTP=normal temperature and pressure).

1-23. (canceled)

24. A process for enriching the content of oxygen in oxygen- and nitrogen-containing gases in a separation apparatus, wherein the interior of said separation apparatus is divided into a substrate chamber and a permeate chamber by an oxygen-conducting ceramic membrane comprising oxygen-transporting ceramic material, and wherein said oxygen-transporting ceramic material is an oxygen-anion- and electron-conducting ceramic material or a combination of oxygen-anion-conducting ceramic material and of electron-conducting material, comprising
(a) compressing and heating an oxygen-containing gas to give a feed gas;
(b) introducing said feed gas into the substrate chamber of said separation apparatus;
(c) introducing an oxygen- and nitrogen-containing sweep gas into the permeate chamber of said separation apparatus;
(d) establishing a pressure in the substrate chamber such that the oxygen partial pressure of the feed gas causes transfer of oxygen through the oxygen-conducting ceramic membrane into the permeate chamber;
(e) removing the feed gas depleted in oxygen from the substrate chamber; and
(f) removing the oxygen-enriched sweep gas from the permeate chamber.

25. The process of claim 24, wherein said oxygen-containing gas is air.

26. The process of claim 24, wherein said oxygen- and nitrogen-containing sweep gas comprises at least 5% by volume of oxygen.

27. The process of claim 24, wherein the pressure of said feed gas in said substrate chamber is in the range of from 10⁻² to 100 bar.

28. The process of claim 24, wherein the temperature of said feed gas in said substrate chamber and of said sweep gas and of said permeate in the permeate chamber is in the range of from 300 to 1500° C.

29. The process of claim 24, wherein the pressure of said sweep gas in said permeate chamber is less than the pressure of said feed gas in said substrate chamber and is in the range of from 10⁻³ to 100 bar.

30. A plant for carrying out the process of claim 24, comprising
A) a separation apparatus inside which a multiplicity of hollow fibers comprising oxygen-conducting ceramic material are arranged parallel to one another, wherein said oxygen-conducting ceramic material is an oxygen-anion- and electron-conducting ceramic material or a combination of oxygen-anion-conducting ceramic material and electron-conducting material, wherein the interiors of said hollow fibers define a permeate chamber of the separation apparatus and the exteriors of said hollow fibers define a substrate chamber of the separation apparatus;
B) at least one component which comprises hollow fibers combined to form bundles and are connected at the end faces to a supply line for a sweep gas and to a discharge line for a permeate gas enriched with oxygen, wherein said supply line and discharge line are not connected to the substrate chamber;
C) at least one supply line for an oxygen-containing feed gas which opens into the substrate chamber of the separation apparatus and is connected to a compressor; and
D) at least one discharge line leading from the substrate chamber of the separation apparatus, for discharging the feed gas depleted in oxygen from the substrate chamber.

31. A plant for carrying out the process of claim 24, comprising
A′) a separation apparatus inside which a multiplicity of hollow fibers comprising oxygen-conducting ceramic material are arranged parallel to one another, wherein said oxygen-conducting ceramic material is an oxygen-anion- and electron-conducting ceramic material or a combination of oxygen-anion-conducting ceramic material and electron-conducting material, wherein the interiors of said hollow fibers define a substrate chamber of the separation apparatus and the exteriors of said hollow fibers define a permeate chamber of the separation apparatus;
B′) at least one component which comprises hollow fibers combined to form bundles and are connected at the end faces to a supply line for an oxygen-containing feed gas, which is connected to a compressor, and to a discharge line for a feed gas depleted in oxygen, wherein said supply line and discharge line are not connected to the permeate chamber;
C′) at least one supply line for a sweep gas which opens into the permeate chamber of the separation apparatus; and
D′) at least one discharge line leading from the permeate chamber of the separation apparatus, for discharging the sweep gas enriched with oxygen from the permeate chamber.

32. A plant for carrying out the process of claim 24, comprising
A″) a plurality of stacked plates or layers of oxygen-conducting ceramic material, which is an oxygen-anion- and electron-conducting ceramic material or a combination of oxygen-anion-conducting ceramic material and electron-conducting material, which form a plurality of spaces arranged parallel and either vertically or horizontally;
B″) a number of said plurality of spaces define permeate chambers and the remainder of said plurality of spaces define substrate chambers, wherein at least one dimension of said spaces is in the range of less than 10 mm, wherein the oxygen transfer between said substrate chambers and said permeate chambers is effected through at least one common wall of the spaces which is formed by a common plate of oxygen-conducting ceramic material;
C″) lines for supplying an oxygen-containing feed gas to said substrate chambers which are connected to compressors and which are connected to at least one distributor unit, said distributor unit being connected to a supply line for the feed gas;
D″) lines for discharging a feed gas depleted in oxygen from said substrate chambers which are connected to at least one collector unit, said collector unit being connected to a discharge line for the feed gas depleted in oxygen;
E″) lines for supplying a sweep gas to said permeate chambers which are connected to at least one distributor unit, said distributor unit being connected to a supply line for the sweep gas;
F″) lines for discharging a sweep gas enriched with oxygen from said permeate chambers which are connected to at least one collector unit, said collector unit being connected to a discharge line for the sweep gas enriched with oxygen; and wherein
G″) said permeate chambers and substrate chambers are not connected to one another.

33. The plant of claim 32, wherein spacer elements are present in all spaces.

34. The plant of claim 30, wherein supply lines to the substrate chamber and/or to the permeate chamber are connected to compressors, by means of which the gas pressure in said chambers can be set independently.

35. The plant of claim 30, wherein the supply line to the permeate chamber is connected to a container from which the plant is supplied with oxygen- and nitrogen-containing sweep gas.

36. The plant of claim 30, wherein an oxide ceramic having a perovskite structure or having a brownmillerite structure or having an aurivillius structure is used as oxygen-conducting ceramic material.

37. The plant of claim 36, wherein said oxide ceramic has a perovskite structure ABO_{3-δ}, wherein A is a divalent cations and B is a trivalent or higher-valent cation, wherein the ionic radius of A is greater than the ionic radius of B, wherein δ is a number between 0.01 and 0.9, and wherein it is possible for A and/or B to be present as a mixture of different cations.

38. The plant of claim 36, wherein said oxide ceramic has a brownmillerite structure A₂B₂O_{5-δ}, wherein A is a divalent cation and B is a trivalent or higher-valent cation, wherein the ionic radius of A is greater than the ionic radius of B, wherein δ is a number between 0.01 and 0.9, and wherein it is possible for A and/or B to be present as a mixture of different cations.

39. The plant of claim 37, wherein A is selected from cations of the second main group, cations of the first subgroup, cations of the second subgroup, cations of the lanthanides, or mixtures thereof.

40. The plant of claim 37, wherein B is selected from cations of groups IIIB to VIIIB of the Periodic Table of the Elements, cations of the lanthanide group, cations of the metals of the fifth main group, or mixtures thereof.
